(19) United States
(12) Patent Application Publication
(10) Pub. No.: US 2010/0005820 A1
(43) Pub. Date: Jan. 14, 2010

(54) Cooling Device for Printing Machines

(75) Inventor: Andreas Harig, Augustdorf (DE)

Correspondence Address: RICHARD M. GOLDBERG, 25 EAST SALEM STREET, SUITE 419, HACKENSACK, NJ, 07601, US

(73) Assignee: TECHNOTRANS AG, Sassenberg (DE)

(21) Appl. No.: 12/523,766

(22) PCT Filed: Jan. 24, 2008
(86) PCT No.: PCT/EP2008/000542

§ 371 Date: Jul. 20, 2009

(30) Foreign Application Priority Data
Jan. 24, 2007 (DE) 10 2007 003 464.6

(51) Int. Cl. F25D 15/00; F25B 39/02; G03B 27/26

(52) U.S. Cl. 62/228.1; 62/515

(57) ABSTRACT

A cooling device for printing machines, includes a refrigerating circuit (10) and a cooling water circuit (12), in which the refrigerating circuit (10)-is provided with a compressor (14) having a compressor drive and a regulator (34). The compressor is configured such that the compressor output of the compressor (14) can be controlled via the regulator independently of the rotational speed of the compressor drive.

The invention relates to a cooling device for printing machines having a primary refrigerating circuit and a secondary cooling water circuit.

During the printing process, printing machines generate heat which has to be dissipated, since it has a negative influence on the print quality. Correspondingly, cooling is brought about during printing with the aid of a dampening solution which is used for offset printing. It is also know to allow a cooling medium, in particular cooling water, to circulate through the interior of the printing press rollers or of some printing press rollers. A largely constant coolant temperature, the range of fluctuation of which lies below 1° C., can have a very favorable influence on the print quality.

In order to achieve a coolant temperature which is precisely constant in this way, regulation can firstly be carried out in the cooling water itself. Secondly, there is also the possibility, however, to already carry out regulation in a primary circuit which is configured as a refrigerating circuit.

The regulation of the refrigerating circuit has the advantage that it is generally possible in apparatus terms with less expenditure. Speed controlled compressors can be used which have the disadvantage, however, that they require relatively expensive frequency converters.

Simply switching the compressor on and off would be inexpensive, but the compressor manufacturers generally limit the permissible switching operations to approximately six per hour. Since this low number of switching operations has to lead to a not inconsiderable laggardness of the regulation, a sufficiently large buffer tank is additionally required for the cooling water, which buffer tank largely absorbs changes in the cooling water temperature and contributes to a substantially constant coolant temperature. The relatively large tank which is required for this purpose makes a system bulky and expensive, with the result that experts strive to omit this tank as far as possible.

What are known as scroll compressors have been disclosed relatively recently, the displacement chamber of which comprises two spirals which engage into one another. The compression action can be switched off suddenly by the spirals being pulled apart in the axial direction, without it being necessary for the motor of the compressor to be switched off. It is therefore possible to switch a scroll compressor on and off without problems and far more frequently than six times per hour and thus to achieve regulation of the compressor performance. This regulation which takes place in each case from 0 to 100 is relatively approximate, however, with the result that it is necessary to carry out smoothing of the regulation profile. As far as can be seen, scroll compressors have not been used previously for cooling systems for printing machines, on account of the very approximate, “digital” control of said compressors.

The invention is therefore based on the object of providing a cooling device of a printing machine, which cooling device makes it possible to keep the coolant temperature largely constant, without a complicated, speed controlled compressor and/or a bulky and spacious compensating tank being required.

This object is achieved by a device corresponding to the main claim. Preferred embodiments are the subject matter of the dependent subclaims.

One aspect of the invention relates to a cooling device for printing machines having a primary refrigerating circuit and a secondary cooling water circuit, the refrigerating circuit having a controller and a compressor with a compressor drive, the compressor being designed in such a way that the compressor performance of the compressor can be controled via the controller independently of the rotational speed of the compressor drive. For example, rotary screw compressors, gear pumps, piston compressors, turbines or similar compressors may be suitable as compressors. Regulation which is independent of the rotational speed can take place, for example, via disengagement of pump elements which are used for the compression, which pump elements can be formed, for example in scroll compressors, by a stationary spiral and a second movable spiral, in rotary screw compressors by spirals which are coiled in opposite directions and mesh with one another, and in gear pumps by gearwheels which mesh with one another. It is likewise conceivable that a similar method of operation is achieved via a subcircuit by virtue of the fact that the low pressure side of the compressor is designed such that it can be connected controllably to the pressure side by means of a fluid connection of the subcircuit, with the result that, if there is an existing fluid connection, preferably no pressure difference or only a small pressure difference can be built up between the low pressure side and the pressure side. This can preferably take place, for example, via an additional or alternatively provided fluid channel which is controlled via a bypass valve and which connects the low pressure side and the pressure side of the compressor to one another or separates them from one another. The term cooling device denotes the arrangement of the refrigerating circuit with the corresponding components and can preferably also have components of the cooling water circuit.

A pulsed fluid flow is preferably generated by this control which is independent of the rotational speed. Here, the compressor performance, that is to say the delivery performance, depends on the pulse duration and the pulse frequency. Via a low pulse duration in comparison with the duration between two pulses, a compressor can preferably be controled constantly between 10% and 100% of the maximum delivery performance, more preferably between 5% and 100% and most preferably between 0% and 100% of the maximum delivery performance. This is the advantage of a compressor of this type, which advantage could not be achieved only by regulation of a drive speed or only with great complexity. In a preferred compressor, however, regulation of the drive speed can be used in addition to the pulsed speed control.

In a preferred cooling device, the controller is at the same time connected to a decompression valve of the refrigerating circuit in such a way that controlling the compressor can be coordinated with controlling the decompression valve.

Furthermore, the cooling device according to the invention is preferably designed in such a way that the refrigerating circuit comprises a digital scroll compressor which can be switched over with the aid of a controller between the switching states “full performance” and “no performance”, and that the controller is at the same time connected to the decompression valve of the refrigerating circuit in such a way that the switching rhythm of the scroll compressor is coordinated with controlling the decompression valve.

Furthermore, it is preferred to provide a device with a combination of an above-described compressor which can be controled independently of the rotational speed, that is to say, for example, a digital scroll compressor, and a permanent compressor. A permanent compressor is a conventional compressor, in which the compressor performance of the permanent compressor depends substantially only on the rotational speed of the compressor drive of the permanent scroll compressor. A conventional permanent compressor of this type can therefore be controled only via the compressor drive, that is to say, for example, via the speed and/or the ratio of a switching on and switching off duration of the compressor drive. A combination of compressor/compressors which can be controled independently of the speed and permanent compressor/compressors has the advantage that conventional compressors are more favorable than, for example, digital compressors of the same size and design. Via a suitable combination of the two compressor types, controlling can be achieved over the entire required controling range, precision control (in particular, in the range just above 0% of the maximum overall compressor performance) preferably taking place via the compressor which can be controled independently of the rotational speed, that is to say, for example, the digital scroll compressor, and the approximate control taking place via one or more conventional compressors being connected in addition or switched off. For this purpose, the compressors are preferably connected in parallel.

By coordinated control of the scroll compressor and the decompression valve in the refrigerating circuit, the temperature profile in the evaporator can be substantially smoothed. If the scroll compressor is switched on and off, for example, in a fixed time cycle, this time cycle can be taken into consideration in the control of the decompression valve. Here, the decompression valve is preferably formed by an electronic valve which can be controled in an continuously variable manner. As a result, the decompression valve can be controled in a very precise manner and in each case under consideration of the current and the following switching state of the scroll compressor.

Furthermore, an embodiment of the decompression valve as a mechanical valve is preferred. A mechanical valve of this type can preferably be provided and/or set independently of the control of the compressor, that is to say without the above-described coordination between the compressor and the valve. Both if an electronic valve is used and also, in particular, if a mechanical valve is used, a pressure compensating element is preferably to be provided behind the decompression valve in the flow direction, between the decompression valve and the compressor, by which pressure compensating element pressure peaks on the low pressure side of the compressor can be compensated for. This has the advantage that pressure peaks which can occur on the low pressure side and which can be disadvantageous, can be reduced or can be avoided, in particular, for a diaphragm of a mechanical valve. A pressure compensating element of this type can be configured, for example, as an compensating container or as a pressure compensating tube. A pressure compensating tube of this type can preferably be soldered perpendicularly onto a refrigerant line which extends between the valve and the refrigerant line. A compressible gas cushion can be built up and maintained in the region of the upper end of the pressure compensating tube, and can contribute to the intended pressure equalization.

Further smoothing of the temperature in the secondary circuit can be achieved by the fact that a very heavy heat exchanger is used as evaporator, that is to say an evaporator type with a large refrigerant or coolant volume. A coaxial heat exchanger may be suitable as a heat exchanger of this type, possibly also a tubular heat exchanger, but less so a conventional plate heat exchanger with a relatively low internal volume.

The invention makes a relatively inexpensive solution of the temperature control problem in printing machines possible. In particular, a large buffer tank for the coolant can be omitted on the secondary side, and the amount of the required cooling water is therefore also reduced. Incidentally, the disposal costs for a relatively large amount of cooling water are dispensed with, and finally the periphery of a pressure system, to which, in particular, the cooling system also belongs, can be simplified and reduced in price considerably.

In the following text, individual particularly preferred embodiments of the invention will be described by way of example. Here, the individual embodiments described have to some extent features which are not necessarily required to realize the present invention, but are generally considered to be preferred. Embodiments which do not have all the features of the embodiments which are described in the following text are therefore also to be considered as disclosed in a manner which falls under the teaching of the invention. It is equally conceivable to combine features selectively with one another which are described in relation to different embodiments.

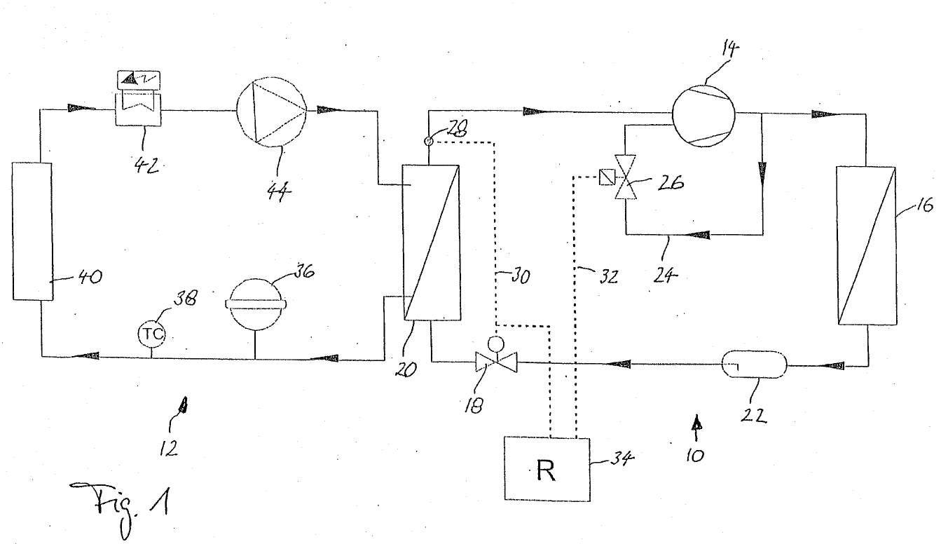

FIG. 1 is a diagrammatic circuit diagram of a cooling device according to the invention.

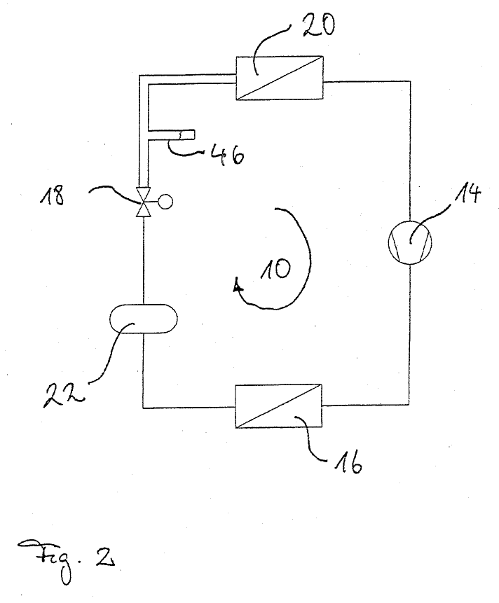

FIG. 2 shows a diagrammatic view of a cooling device according to the invention having a mechanical decompression valve and a pressure compensating element.

FIG. 1 shows a refrigerating circuit 10 on the right hand side and a coolant circuit 12 on the left hand side. In particular, water may be suitable as coolant within the coolant circuit.

The refrigerating circuit comprises a compressor 14 which has a compressor drive (not shown separately), for example in the form of an electric motor or an internal combustion engine, and which is preferably a constituent part of the compressor 14, a condenser 16, a decompression valve 18 and an evaporator 20 which are arranged in a circuit in the stated sequence. 22 denotes a collecting container for the condensed liquid, which collecting container performs a certain buffering function in the refrigerating circuit.

A subcircuit 24 connects the output side to the input side of the compressor. The subcircuit 24 comprises a bypass valve 26.

If the bypass valve 26 is opened, the refrigerant which leaves the compressor 14 in the compressed state is used to press the two spirals apart. In this stage, the compressor runs without any performance.

The subcircuit 24 therefore symbolizes the function of what is known as a scroll compressor. A scroll compressor has a displacement chamber which is formed by two spirals which engage into one another. If the two housing parts are pulled apart axially, the compression action is interrupted suddenly. This switching operation can be carried out as often as desired and at any desired time cycle. It is therefore possible to control the compressor 14 in such a way that it is switched on and off at a predefined pulse/pause ratio. This method of operation is therefore not possible in a conventional compressor because switching on and off is possible only with restrictions, as explained in the introduction, with regard to the desired service life.

A temperature probe 28 is situated in the refrigerating circuit downstream of the evaporator 20. The movement direction of the refrigerant in the refrigerating circuit is indicated by arrows.

The expansion valve 18, the bypass valve 26 and the temperature probe 28 are connected to a control unit 34 via control lines 30, 32.

Before the method of operation of the refrigerating circuit controller according to the invention is shown, first of all the coolant circuit 12 is to be explained briefly. In the evaporator 20 which is configured as a heat exchanger, heat exchange occurs between the evaporating refrigerant and the cooling water in the coolant circuit. Otherwise, a buffer container 36 and a temperature sensor 38 are situated in said coolant circuit in front of the symbolically indicated printing press roller 40 and an optional heating device 42, and a circulating pump 44 is situated behind the printing press roller 40 between it and the evaporator heat exchanger 20. The printing press roller 40 symbolically represents the consumer points of a printing machine which require cooling. The heating device 42 is provided for the case where the coolant flow in the coolant circuit 12 has dropped to an excessively low temperature. The temperature sensor 38 checks the temperature of the coolant.

According to the invention, however, the temperature control is to take place primarily in the primary circuit, that is to say in the refrigerating circuit 10.

As has already been mentioned, the compressor 14 is preferably a scroll compressor, in particular a digital scroll compressor. The special feature of a digital scroll compressor comprises the ability to control the two spirals which are used to compress the refrigerant. Here, the two spirals can preferably be disengaged in the axial direction and make it possible in this way to switch the compression performance on and off, without it being necessary for the drive motor to be switched off. Here, the two spirals can preferably either be disengaged and do not supply any performance in this case, or they can be pushed together and held together and then supply the maximum compression performance. This is therefore essentially a pure yes/no control, with the result that one can refer to a digital compressor. The performance control can be carried out by pulse width modulation, in which the ratio of the on and off phases of the compressor or the pulse duration and the pulse frequency are varied. It is conceivable here to set or to control the pulse frequency with a constant pulse duration and/or to set or to control the pulse duration with a constant pulse frequency. It is also conceivable to influence both the pulse duration and the pulse frequency.

For example, in order to achieve 10% performance, delivery takes place for 1 second and delivery is paused for 9 seconds in the case of a 10 second cycle. Accordingly, cooling is carried out only for 1 second and no cooling is carried out for 9 seconds in the evaporator. As a result, undesirably high temperature fluctuations can be produced on the cooling water side. This is to be avoided. This preferably takes place by coordination of the electronic valve with the scroll compressor. For example, the electronic valve is already opened in a leading manner before the compression phase of the compressor.

In another example, in a switching cycle of 20 seconds or in the resulting pulse frequency, the compressor is closed for 2 seconds and held open for 18 seconds for 10% of the refrigerating performance, and is held closed for 20 seconds for 100% of the performance.

However, comparable controling can also be used in a digital scroll compressor for other compressor types which have already been mentioned.

In particular, if this type of digital control is coordinated with the control of the decompression valve 18, very precise and continuous control of the refrigerating circuit is possible, which ultimately makes it possible to keep the cooling water temperature below a hysteresis of 1° C.

Furthermore, coordination of the bypass valve 26 and the decompression valve 18 via the common control unit 34 can be advantageous. Thus, for example, if carried out correctly, anticipating control of the decompression valve 18 can be achieved, by which the pressure fluctuations in the refrigerating circuit and, as a result, ultimately the temperatures in the coolant circuit 12 are largely equalized.

One preferred embodiment of the invention relates to a cooling device for printing machines having a primary refrigerating circuit 10 and a secondary cooling water circuit 12, the refrigerating circuit 10 comprising a digital scroll compressor which can be switched over with the aid of a controller 26, 32 between the switching states “full performance” and “no performance”, and the controller 34 at the same time being connected to the decompression valve 18 of the refrigerating circuit 10 in such a way that the switching rhythm of the scroll compressor is coordinated with the control of the decompression valve 18.

In a device of this type, the decompression valve 14 is preferably configured as a valve which can be controled in an continuously variable manner. Here, the decompression valve is preferably a decompression valve which can be controled electronically.

Furthermore, in a device of this type, the evaporator 20 is preferably configured as a coaxial heat exchanger and/or as a tube heat exchanger.

In FIG. 2, a further preferred embodiment is described, in which a mechanical decompression valve 18 is preferably used instead of the previously described electronic decompression valve 18. The shown embodiment has substantially the same assemblies and features as have already been described in relation to FIG. 1, but which are not shown once more in FIG. 2 and are not described again in the following text either. For the sake of brevity, only the differences will be described in greater detail in the following text.

The mechanical decompression valve 18 is preferably not set and/or controled as a function of a compressor controller, with the result that the decompression valve is preferably not connected to the control unit via a control line. This has the advantage that costs can be saved by the use of the mechanical decompression valve 18 and by the coordination which is not required, in comparison with the electronic decompression valve 18. However, some mechanical valves are more susceptible to faults as a result of their design, induced when used in a system, in which pressure fluctuations prevail during operation, as are caused by the use of the described digital compressors 14.

The pressure fluctuations in the system, in particular when the digital scroll compressor is disengaged, are caused by the fact that, when the spirals are disengaged, the inlet side of the compressor is connected to the outlet side in terms of flow mechanics. As a result, the two sides can communicate substantially freely with one another. As a result, the cooling fluid which is present in compressed form on the pressure side before the disengagement operation can expand, with the result that a pressure surge is produced on the inlet side. The pressure differences which occur during operation can readily be 3 to 4 bar or more. Said pressure surges are transmitted by the evaporator to the decompression valve.

A nonreturn valve (not shown) can therefore preferably be provided on the inlet side of the compressor, which nonreturn valve protects the decompression valve from the pressure surge. Furthermore, it is conceivable, instead of or in addition to the nonreturn valve, to provide a valve (likewise not shown), for example a shutoff valve, which can be controlled and/or controled and preferably shuts off the refrigerant line toward the decompression valve shortly before the disengagement operation, with the result that a pressure surge can be avoided during disengagement.

Instead of these embodiments, a pressure compensating element 46 is provided in FIG. 2, which pressure compensating element 46 is preferably provided just behind the decompression valve in the flow direction.

In this region, the refrigerant is present for the greatest part in liquid form during operation of the cooling device. Pressure surges on the low pressure side of the cooling device therefore have a particularly pronounced effect, which pressure surges are transmitted in this region in the medium which is liquid and therefore compressible only to a small extent. It is therefore advantageous preferably to attenuate or completely equalize said pressure surges just behind the decompression valve.

A pressure compensating element 46 of this type can be configured, for example, as an compensating container or as a pressure compensating tube. As shown, a pressure compensating tube of this type can preferably be soldered, preferably perpendicularly, onto a refrigerant line which extends between the valve and the refrigerant line. In the region of the upper end of the pressure compensating tube, a compressible gas cushion can be built up and maintained above the liquid coolant which is situated below it. The compressible gas cushion can contribute to the intended pressure equalization.

### LIST OF DESIGNATIONS

10 Refrigerating circuit

12 Cooling water circuit

14 Compressor

16 Condenser

18 Decompression valve

20 Evaporator

22 Collecting container

24 Subcircuit

26 Bypass valve

28 Temperature probe

30 Control line

32 Control line

34 Controller

36 Buffer container

38 Temperature sensor

40 Printing press roller

42 Heating device

44 Circulating pump

46 Pressure compensating element

What is claimed is:

1. A cooling device for printing machines, comprising:
a refrigerating circuit having a controller and a compressor with a compressor drive, the compressor being designed in such a way that performance of the compressor is adapted to be controlled via the controller independently of rotational speed of the compressor drive, and
a cooling water circuit connected with the refrigerating circuit.

2. The cooling device as claimed in claim 1, wherein the refrigerating circuit further includes a decompression valve, and the controller is connected to the decompression valve of the refrigerating circuit in such a way that control of the compressor is adapted to be coordinated with control of the decompression valve.

3. The cooling device as claimed in claim 1, wherein the compressor is a digital compressor which is adapted to be switched over with the aid of the controller between switching states of “full performance” and “no performance”.

4. The cooling device as claimed in claim 1, wherein the digital compressor is a digital scroll compressor.

5. The cooling device as claimed in claim 1, wherein the digital compressor is a digital rotary screw compressor.

6. The cooling device as claimed in claim 2, wherein control of the compressor and control of the decompression valve are coordinated in such a way that a switching rhythm of the compressor is coordinated with the control of the decompression valve.

7. The cooling device as claimed in claim 2, wherein the decompression valve is an electronic valve.

8. The cooling device as claimed in claim 2, wherein the decompression valve is a mechanical valve.

9. The cooling device as claimed in claim 2, further comprising a pressure compensating element provided behind the decompression valve in the flow direction, between the decompression valve and the compressor.

10. The cooling device as claimed in claim 9, wherein the pressure compensating element is configured as a compensating container.

11. The cooling device as claimed in claim 10, wherein the compensating container is configured as a pressure compensating tube.

12. The cooling device as claimed in claim 11, wherein the pressure compensating tube is arranged on a refrigerant line which extends between the decompression valve and the compressor, the pressure compensating tube extending upward from the refrigerant line.

13. The cooling device as claimed in claim 2, wherein the decompression valve is configured as a valve which is adapted to be controlled in a continuously variable manner.

14. The cooling device as claimed in claim 1, further comprising an evaporator.

15. The cooling device as claimed in claim 14, wherein the evaporator has a coaxial heat exchanger.

16. The cooling device as claimed in claim 14, wherein the evaporator has a tube heat exchanger.

17. The cooling device as claimed in claim 1, further comprising a second compressor.

18. The cooling device as claimed in claim 17, wherein the second compressor has a permanent compressor.

19. The cooling device as claimed in claim 18, wherein the permanent compressor has one of:
a scroll compressor and
a rotary screw compressor.

20. The cooling device as claimed in claim 18, wherein the permanent compressor is arranged parallel to the first-mentioned compressor.
